(19) United States
(12) Patent Application Publication
(10) Pub. No.: US 2025/0371990 A1
(43) Pub. Date: Dec. 4, 2025

(54) Smart Busy Board

(71) Applicant: Hannah Ramirez De Arellano, Lakeland, FL (US)

(72) Inventor: Hannah Ramirez De Arellano, Lakeland, FL (US)

(21) Appl. No.: 18/733,171

(22) Filed: Jun. 4, 2024

(51) Int. Cl. G09B 5/06; A63H 33/00

(52) U.S. Cl. CPC G09B 5/06; A63H 33/006

(57) ABSTRACT

A smart busy board is provided utilizing a technology driven timer which can be set to predetermined time intervals for each of a plurality of interactive components disposed on the smart busy board. The timer mechanism and some of the interactive components are connected to electrical elements hidden within the interior housing of the smart busy board. Each of the interactive components engage the infant or toddler with some type of sensory output, such as movement, sound, light, and touch for a predetermined time interval. The busy board is designed to stimulate frontal lobe and cognitive development and improve motor skills.

### FIELD OF INVENTION

The present invention relates to a smart busy board for infants and toddlers. More specifically, the smart busy board utilizes a technology driven timer which can be set to predetermined time intervals for each of a plurality of interactive components disposed on the smart busy board. Some of the interactive components are connected to electrical elements hidden within the interior housing of the smart busy board. Each of the interactive components engage the infant or toddler with some type of sensory output, such as movement, sound, light, and touch for a predetermined time interval. The busy board is designed to stimulate frontal lobe and cognitive development and improve motor skills.

### BACKGROUND OF THE INVENTION

Amusement devices intended to engage an infant, toddler or small child are well known in the prior art. In some instances, these amusement devices simply are designed to keep a child pre-occupied and have little educational or learning value. Busy boards are wonderful Montessori-based devices that are designed for interaction with users between the ages of 6 months and 4 years. The original busy board devices were aimed to promote frontal lobe development, fine motor skill development and overall cognitive development for children in this age group. However, every busy board requires an adult or caregiver to help guide the child on learning how to interact with each component. Infants between 6 and 18 months in particular have very short attention spans. As a parent or person showing the child how to interact with the device, that parent of person must remain with the child throughout the entire “play session” of the device in order for the child to benefit from interacting with the device. While parents want their children to interact with the busy board type toys, this generation of parents are quite busy themselves. Toys that light up, have screens and/or explosively loud noise effects may keep a child “busy” but these types of toys have absolutely no educational or developmental benefit for the child.

### PRIOR ART

The prior art includes a myriad of devices and toys for occupying an infant or toddler and relating to interactive learning tools. In U.S. Patent Application Publication 2015/0224414 A1 to Aboukrat et al., an amusement device is provided which can be mounted on a furniture having a supporting wall or on a regular wall. The device has two sides, each with a unique stimulating theme. The first face has moving parts and noise-inducing elements and the second face has illuminating elements. Other infant educational play devices are disclosed, for example, in U.S. Pat. No. 5,971,761 to Tillman, Sr, U.S. Patent Application Publication 2003/0171065 A1 to Greenberg and U.S. Patent Application Publication 2011/0163499 A1 to Weiss. Despite the attempts of the prior art, a need still exists for a smart busy board that utilizes a timer mechanism that when started will cause a plurality of mechanisms on the busy board to be activated in random order for a predetermined time interval.

### SUMMARY OF THE INVENTION

The invention of the present subject matter relates to smart busy board utilizing a timer mechanism which can be set to predetermined time intervals for each of a plurality of interactive components disposed on the smart busy board. The timer mechanism and at least some of the plurality of interactive components are connected to electrical elements hidden within the interior housing of the smart busy board. Each of the interactive components is designed engage the infant or toddler with some type of sensory input, such as movement, sound, light, and touch for a predetermined time interval. The busy board is designed to stimulate frontal lobe and cognitive development and improve motor skills.

Accordingly, it is an object of the present subject matter to provide a smart busy board having a timer mechanism which can be set for a predetermined time interval for each of a plurality of interactive components disposed within the smart busy board.

It is another object of the present subject matter to provide a smart busy board having a plurality of interactive components, each providing at least one type of sensory output, such as movement, sound, light, and touch.

It is yet another object of the present subject matter to provide a smart busy board wherein the timer mechanism and at least some of the interactive components are connected to electrical elements hidden within the interior housing of the smart busy board, safely away from the infant or toddler.

It is still another object of the present subject matter to provide a smart busy board wherein each of the interactive components connected to an electrical element are capable of movement, creating a sound, or illumination at the initiation of the predetermined time interval and can continue such sensory outputs when engaged by the infant or toddler.

It is a further object of the present subject matter to provide a smart busy board having a timer mechanism which can be adapted to the age and attention span of the infant or toddler.

It is a further object of the present subject matter to provide a busy board that can be set at a predetermined interval schedule to cycle through each of the plurality of components for a period ranging from about 30 seconds to about 120 seconds each.

It is still a further object of the present subject matter to provide a smart busy board that will engage an infant or toddler for a period of time between about nine (9) minutes and about thirty-five (35) minutes.

It is an additional object of the present subject matter to provide a smart busy board that has a plurality of interactive components that are not connected to the electric elements yet are designed to engage the infant or toddler's attention and provide a sensory output to enhance frontal lobe development and motor skills.

It is yet a further object of the present invention to provide a smart busy board which provides the parent, guardian or caregiver with a respite knowing that the infant or toddler is engaged with the smart busy board for a predetermined period of time.

It is an additional object of the present invention to provide a smart busy board which provides the parent, guardian, or caregiver with the comfort of knowing that the infant or toddler is not being overstimulated by a display screen or toy that does not help frontal lobe or cognitive development.

These and other objects of the present subject matter are accomplished by providing a smart busy board having a timer mechanism and a plurality of interactive components, the timer mechanism and at least some of the plurality of interactive components being connected to electrical elements hidden within the interior housing of the smart busy board and wherein each of the interactive components engage the infant or toddler with some type of sensory input, such as movement, sound, light, and touch for a predetermined time interval.

### BRIEF DESCRIPTION OF DRAWINGS

FIG. 1 is a side perspective view of the smart busy board of the present subject matter mounted to a standing device.

FIG. 2 is a front view of the smart busy board of the present subject matter showing a first embodiment of a layout of a plurality of interactive components.

FIG. 3 is a front view of the smart busy board the present subject matter showing a second embodiment of the layout of a plurality of interactive components.

FIG. 4 is a rear view of the smart busy board of the present subject matter illustrating the mounting brackets for hanging the smart busy board on a wall.

### DETAILED DESCRIPTION OF THE INVENTION

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements and are not drawn to scale. In the following description, numerous specific details are set forth to clearly describe various specific embodiments disclosed herein. One skilled in the art, however, will understand that the presently claimed invention may be practiced without all the specific details discussed below. In other instances, well known features have not been described so as not to obscure the invention.

It is to be understood that the terms “smart busy board”, “busy board”, and “board” may be used interchangeably throughout this specification and claims and each term refers to the smart busy board of the present subject matter. It also is to be understood that although the terms “infant”, “toddler”, “infant or toddler”, “user”, or “child” may be used interchangeably throughout this specification and claims.

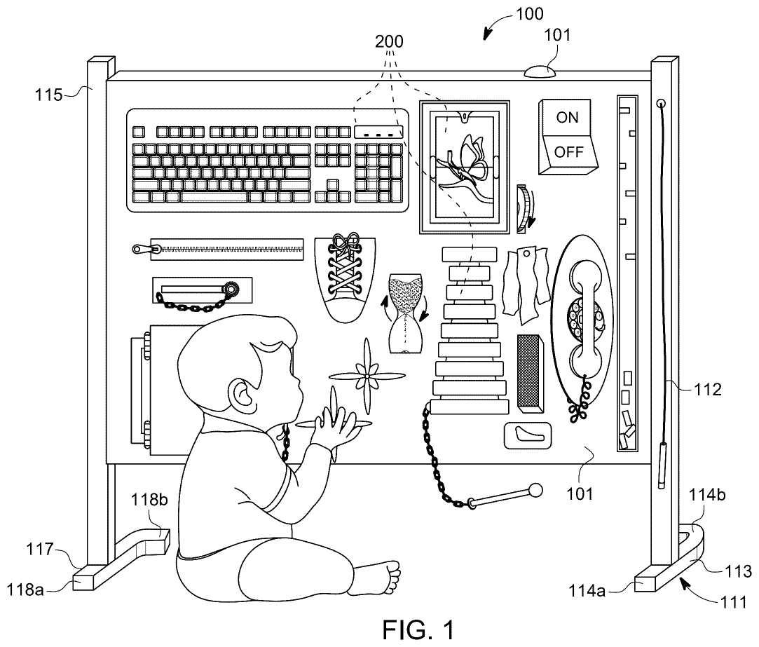

The present subject matter is directed to a smart busy board comprising a timer mechanism and a plurality of interactive components located on the front surface of the smart busy board. The timer mechanism controls the electrical elements of each of the plurality of interactive components, the electrical elements being secured inside the smart busy board, safely hidden from the child. Referring to FIG. 1, a first embodiment is illustrated with a toddler shown playing with a smart busy board 100 which is mounted on an upright stand 110 comprising two mounting posts each having an upright leg member and a foot member designed to maintain the stability and support of the busy board while mounted on the upright stand when a child is pushing, pulling, twisting, and otherwise engaging with the plurality of interactive components on the board. More particularly and as shown in the Figures, the smart busy board 100 comprises a front panel 101, rear panel 102, the front panel and rear panel being connected by a top surface 103, a bottom surface 104, a left side surface 105 and a right side surface 106, together creating an interior space within which electrical elements are stored and hidden from view. Mounting post 111 has an upright leg member 112 which is adapted to be securely attached to the left side surface 105 of the board and at its lower end is connected to a foot member 113 having a front end 114A which extends outwardly from the front surface of the board and a rear end 114B which extends outwardly from the rear surface of the board and then curving inwardly. Similarly, mounting post 115 has an upright leg member 116 which is adapted to be securely attached to the right side surface 106 of the board and at its lower end is connected to a foot member 117 having a front end 118A which extends outwardly from the front surface of the board and a rear end 118B which extends outwardly from the rear surface of the board and then curving inwardly.

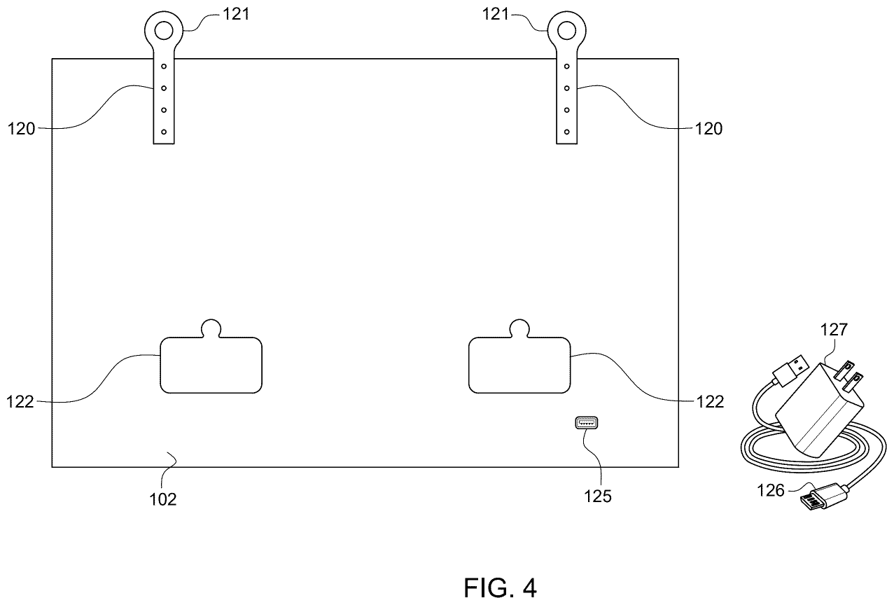

In a second embodiment as shown in FIG. 4, at least two mounting brackets 120 are provided on the rear surface 102 of the busy board 100 of the present subject matter such that the busy board can be mounted to a wall. Each of the mounting brackets is provided with an upper aperture 121 which extends above the top surface, the upper aperture being of sufficient diameter to receive a nail, screw, or similar mounting means for securely mounting the busy board to a wall.

As shown in FIG. 4, the lower end of the rear surface is provided with a least one compartment 122 to contain a power source to power the electrical elements. The electrical elements can be powered by any suitable power source as will be obvious to those skilled in the art. In a preferred embodiment, the electrical elements are powered by an array of batteries contained in two battery compartments disposed within the rear surface of the smart busy board. In another embodiment, the power source can be rechargeable by means of a USB port 125 shown in the lower right corner of the rear surface, with a charging cord 126 and power block 127.

The smart busy board 100 of the present subject matter is sized with dimensions sufficient to enable an infant or toddler to engage with the entire face of the busy board and the interactive components. In one embodiment, the length of the busy board 100, is between about thirty inches (30″) and about thirty-six inches (36″), the height is between about twenty-two inches (22″) and about twenty-eight inches (28″), and the depth is between about four inches (4″) and about six inches (6″), the depth being of sufficient size such the electrical elements of the busy board can be securely stored and hidden within the interior space. However, it is to be understood that the actual dimensions can be modified without departing from the intended scope of the present subject matter.

The top surface 103 of the busy board 100 is provided with a timer mechanism in the form of a technology driven timer dial 101 which is connected to the electrical elements contained within the interior space. The timer dial 101 can be set to a predetermined time interval such as 30 seconds, 60 seconds, 90 seconds, or 120 seconds based on the age and attention span of the infant or toddler. This predetermined interval setting controls the amount of time for engagement with each of the plurality of interactive components disposed on the smart busy board. Utilizing the timer dial 101 on the top surface of the board enables a parent, guardian, or childcare provider the decision capability to set the dial to a particular time interval to hold the infant or toddler's attention during independent play. Depending on the number of interactive components disposed on the busy board and the timer setting, the infant or toddler can be entertained while promoting curiosity, frontal lobe development, and sharper motor skills. For example, it is contemplated that a minimal engagement with the busy board 100, based on three rounds through each of the plurality of interactive component at a thirty second time interval will entertain the infant or toddler for about six minutes. A good engagement with the busy board based on three to six rounds through each of the interactive components at a thirty second time interval will entertain the infant or toddler for about six to about twelve minutes. Dream engagement with the busy board, based on six to nine rounds through each of the interactive components at a thirty second time interval will entertain the child for between about twelve minutes and about eighteen minutes. Increasing the time interval from thirty seconds to a longer time interval will increase the amount of time the infant or toddler will be engaged with the smart busy board.

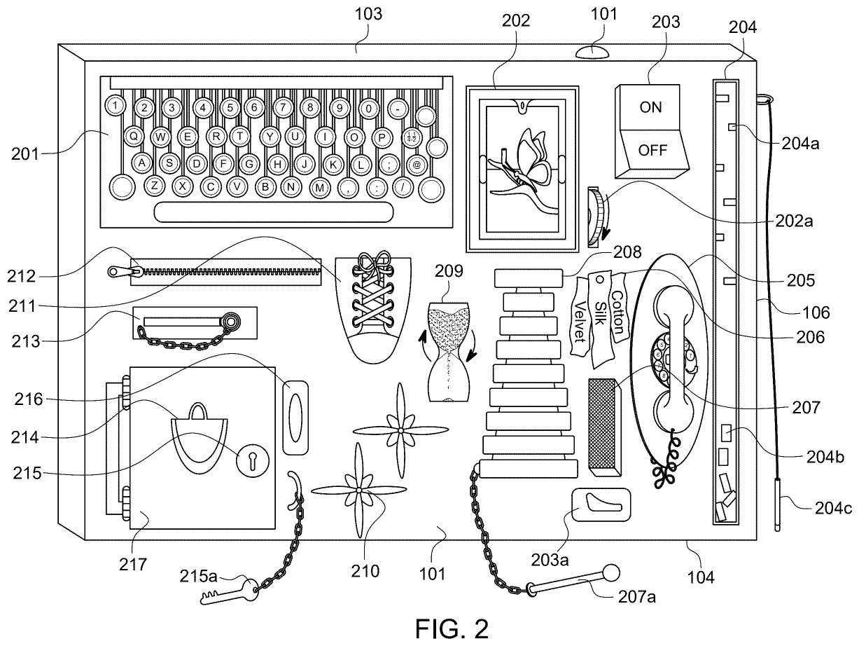

Referring now to FIGS. 1 and 2, disposed on the front surface 101 of the smart busy board 100 is a plurality of interactive components 200. In the embodiment illustrated in FIGS. 1 and 2, seventeen (17) interactive components are disposed on the front surface 101. Eleven of the interactive components in this embodiment are connected to the electrical elements hidden within the interior space and are referred to as self-moving interactive components. The remaining six interactive components are not connected to the electrical elements. More particularly, the interactive components depicted in FIGS. 1 and 2 comprise a vintage typewriter keyboard 201, a flip page front facing moving picture book 202, a vintage on/off sign 203, a magnetized book shelf 204, a vintage rotary phone 205, a fabric collection 206, a hard bristle tooth brush 207, a xylophone 208, an hourglass 209, gear wheels 210, a shoe 211, a zipper 212, a sliding latch and lock 213, a classic doorknocker 214, a doorknob with a key 215, a standard doorbell 216 and a door 217.

The interactive typewriter keyboard component 201 is provided with numbers zero to nine (0 to 9) and the 26 letters of the alphabet, such that when the infant or toddler presses a button having a letter associated thereon, the busy board will announce the letter and phonetic sound. Similarly, for a button having a number associated thereon, the busy board will announce the number. It is contemplated that when dial timer 101 is activated and set to the desired time interval, the initiation of time interval sequence will begin with the first interactive component, in this embodiment, typewriter keyboard 201. Once the time interval has been initiated, the buttons with the letters A, B, and C will first automatically and sequentially appear to press down and announce the corresponding phonetic sound. For the remainder of the time interval, the user can engage the keyboard 201 by pressing down on any of the buttons and the busy board will announce the corresponding letter and phonetic sound and number.

The flip page front facing moving picture book 202 is controlled by a round disc 202A on one side of the book component. The infant or toddler can turn the disc downward to move the pages of the picture book to show a changing image, for example a caterpillar turning into a butterfly. The picture book 202 is set inside the board and covered with a plexi-plastic material to prevent the infant or toddler from ripping out pages from the book. The round disc 202A will spin for an interval page flips, such as three-to-four page flips.

The vintage on/off sign 203 is a self-moving interactive component connected to the electric components. The on/off sign 203 will light up when a light switch 203A disposed near the lower surface of the board 101 is flipped upwardly. When the light switch is flipped upwardly, the “on” portion of on/off sign 203 will be illuminated and when the light switch is flipped downwardly, the “off” portion of the on/off sign 203 will be illuminated. When this timed interval for the on/off sign is first initiated, the light switch 203A automatically will flip “on” and then flip “off” and the respective portions of the on/off switch will illuminate. This showing of how the light switch 203A works, promotes the infant or toddler to flip the light switch on and off themselves.

Interactive component 204 is a column of colored shelves 204A, for example red-orange-yellow-green-blue-violet colors from top to bottom. Each of the shelves contains a magnetic element. Inside the shelves are disposed a series of color-coordinated books 204B with magnets inside. A magnetic pen 204C connected to a curling cord is attached to the board. The infant or toddler uses the magnetic pen 204C to grab and move each of the colored magnetic books 204B to the corresponding-colored shelf 204A.

The vintage rotary phone 205 is another self-moving interactive component. At the initiation of this time interval, the rotary will spin and a ringing sound will be heard. When the user spins the rotary dial 205A, the board will announce the number on the rotary dial that was spun. When the user picks up the phone off the hook, the board 101 will play various phrases through the phone receiver for the infant or toddler to hear. Examples of such phrases include “hello”, “goodbye”, “hola”, and similar short phrases that a toddler between about 12 months and about 24 months could attempt to imitate. In another embodiment, the rotary phone component could “parrot back” or repeat what the child says into the phone. The rotary phone 205 also will ring after being hung back on the receiver.

Fabric collection 206 and hard bristle tooth brush 207 are two texturized interactive components which the infant or toddler can touch and experience the feel of the fabric. By way of example, the fabric collection may include cotton, silk, and velvet fabric pieces. The xylophone 207 is another interactive component, each note colored from top to bottom, for example in a red-orange-yellow-green-blue-indigo-violet color scheme. A mallet 207A is connected to the top of the xylophone by a curling cord which the child can use to strike each of the several colored notes on the xylophone.

The hour glass 208 is a self-moving interactive component. When this time interval is initiated, the hourglass will spin twice by itself. Thereafter, the infant or toddler can spin the hourglass for the time remaining in the time interval. Gear wheels 209 also is another self-moving interactive component. When this time interval is initiated, the gears will spin twice by themselves for several seconds; the infant or toddler can then engage and spin the gear wheels.

The shoe 211 is an interactive component having shoelaces which cannot be removed completely from the shoe. The user can play with the shoelaces and pretend to tie them together. The rainbow zipper 212 is a self-moving interactive component which upon initiation of this time interval, the zipper will unzip and re-zip. The sliding latch and lock 213 is another self-moving interactive component which upon initiation of the time interval will slide back and forth once. The initiation of each of these self-moving interactive components 212 and 213 show the child how component is supposed to work which aids in frontal lobe development and promotes motor skills. The infant or toddler's engagement with both the zipper 212 and latch and lock 213 will be to repeat the motion (e.g. zipping).

The classic doorknocker 214, the doorknob with key 215, and the standard press doorbell 216 each are self-moving interactive components; the doorknocker and doorknob both are located on little wood door 217 interactive component while the doorbell 216 is situated next to the door 217. At the initiation of the time interval for the classic doorknocker 214, the knocker will be knocked twice and the user then can knock on the wood door. The doorknob with key 215 includes a chain connected to the key. When the time interval initiates this activity, the doorknob will jiggle and twist. The key will not lock the door, but the infant or toddler can practice inserting and removing the key from the doorknob. At the initiation of the standard press doorbell 216, the doorbell will light up. The infant or toddler can press the doorbell 216 and hear an actual ring from the smart busy board. The door 217 interactive component preferably is a brightly colored door, such as a red door, and when opened manually, a mirror is revealed.

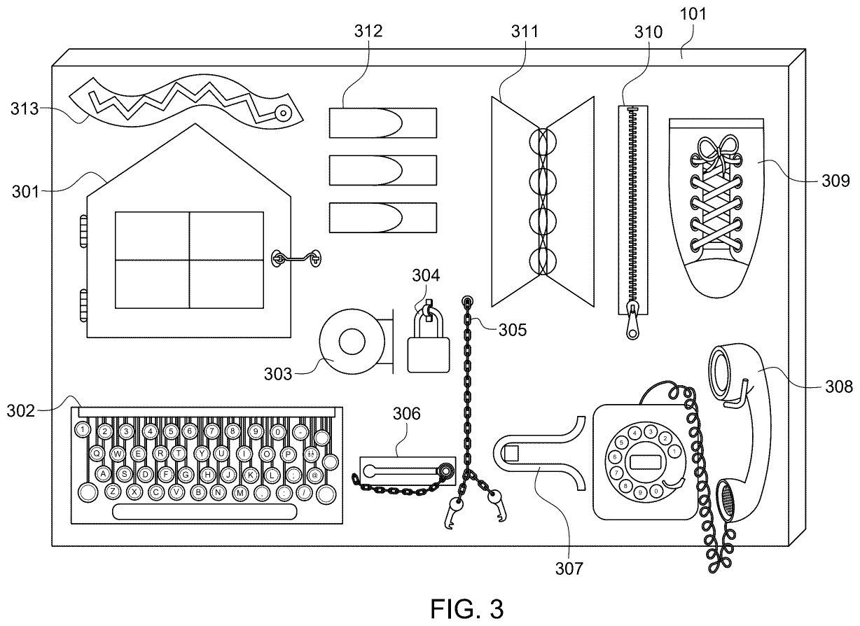

Referring to FIG. 3, a second embodiment of the smart busy board 100 of the present subject matter is illustrated. In this embodiment, thirteen (13) interactive components are disposed within the face of the busy board, eleven (11) of which are self-moving. More particularly, the plurality of interactive components in this second embodiment comprises a hinged door 301, a vintage keyboard 302, a doorknob and key 303, a padlock 304, keys-on-a-chain 305, a chain lock 306, a swing bar lock 307, a vintage rotary phone 308, a painted shoe top 309, a zipper 310, a pair of buttonable fabric pieces 311, Velcro™ straps 312 and zig-zag pattern 313.

The hinged door 301 is a self-moving interactive component comprising a lock 301A in the form of gate hook and eye combination and a small window 301B; when the door is opened a mirror is revealed, which can be viewed by the infant or toddler through the small window. When timer dial 101 is activated with the selected predetermined time interval, the initiation of the time interval for the hinged door will cause the door to shake or push against the lock 301A, thereby creating both movement and noise.

The vintage keyboard 302 also is a self-moving interactive component and functions in the same manner as the vintage typewriter keyboard 201. The doorknob and key 303 is a self-moving interactive component that will twist and jiggle upon initiation of the time interval. As with doorknob component 215, the doorknob is not lockable but the child can practice inserting and removing a key. The padlock 304 is another self-moving interactive element that can be unlocked. Upon initiation of the time interval, the padlock base connected to the board will cause the padlock to swing back and forth. The padlock 304 is designed with a large arm piece such that it cannot be removed from the busy board. The keys-on-a-chain 305 is a self-moving interactive component and preferably includes at least two keys which can be inserted into the doorknob and/or the padlock. Upon initiation of the time interval, movement of the keys on a chain 305 will be created, such movement may include jiggling, twisting quickly halfway or twisting back and forth several times, the movement being designed to cause the keys swing. It is to be understood that the keys can be identical or each key can be designed for a specific interactive component. The chain lock 306 and the swing bar lock 307 both are self-moving interactive components capable of movement. Upon initiation of the corresponding time interval, the chain lock 306 will slide back and forth twice while the swing bar lock 307 will swing open and close one time.

The vintage rotary phone 308 is a self-moving interactive component similar to the rotary phone component 205 of the embodiment shown in FIG. 2. Upon initiation of the time interval, the rotary phone dial will swirl, stop and recoil back to its starting point one or more times. The infant or toddler thereafter can engage the rotary dial.

The painted shoe top 309 is an interactive component with shoelaces and eye holes to lace the shoelaces through the eyeholes. The top end of the shoelaces is securely attached to the far end of the shoe so that they cannot be removed from the board. Zipper 310 is another self-moving interactive component and functions in the same manner as rainbow zipper 212. The pair of buttonable fabric pieces 311 is an interactive component comprising a pair of cloth pieces with buttons and holes such that the child can button the pieces of cloth together and unbutton the pieces as well. The Velcro™ straps 312 is a self-moving interactive component which is provided with a space on the outer edges in such a manner that upon initiation of the time interval, each set of straps can move back and forth to engage the child's attention. It is contemplated that more than one set of Velcro™ straps will be provided on the busy board and each set of Velcro™ straps will move. The child can than practice attaching and detaching the Velcro strap arrangement of each set. Zig-zag pattern 313 is another self-moving interactive component which is a “follow the pattern” zig-zag pattern carved into wood and which is provided with a bar member than can move through the zig-zag design. Upon initiation of the time interval, the bar member will be moved forward and back along the zig-zag pattern in order to engage the child to repeat the movement.

Numerous interactive components have been disclosed and described herein and it is to be understood that these interactive components merely are illustrative and exemplary and should not be considered limiting of the type, kind or number of interactive components that can be utilized with a smart busy board of the present subject matter. Further, as will be obvious to those skilled in the art, the two embodiments of the smart busy board of the present subject matter are intended merely to be illustrative and non-limiting.

While several illustrative embodiments of the invention have been shown and described, numerous variations and alternative embodiments will occur to those skilled in the art. Such variations and alternative embodiments are contemplated and can be made without departing from the scope of the invention as defined in the appended claims.

1. A smart busy body comprising a front panel and a rear panel, said front panel and said rear panel being connected by a top surface, a bottom surface, a first side surface and a second side surface, thereby creating an interior space, said front panel having a face surface further comprising a plurality of interactive components disposed therein, said top surface having a timing mechanism, said timing mechanism and at least some of said plurality of interactive components being connected to electrical elements contained with said interior space.

2. The smart busy board in accordance with claim 1, further comprising a mounting stand comprising a first mounting post having an upright leg member securely attached to said first side surface and a second mounting post having an upright leg member securely attached to said second side surface, each of said first mounting post and said second mounting post further comprising a horizontal foot member having a front end extending forwardly from said mounting post and a rear end extending rearwardly and curving inwardly from said mounting post.

3. The smart busy board in accordance with claim 1, wherein said rear panel further comprises at least two mounting brackets designed to securely mount said smart busy board to a wall.

4. The smart busy board in accordance with claim 1, further comprising a power source to power said electrical elements.

5. The smart busy board in accordance with claim 4, wherein said power source in the form of a plurality of batteries.

6. The smart busy board in accordance with claim 4, wherein said power source is in the form of at least one rechargeable battery.

7. The smart busy board in accordance with claim 6, wherein said at least one rechargeable battery is electrically connected to a USB port disposed in the rear panel of said smart busy board.

8. The smart busy board in accordance with claim 1, wherein said at least some of said plurality of interactive components being connected to said electrical elements are self-moving interactive components.

9. The smart busy board in accordance with claim 1, wherein said timing mechanism is in the form of a timer dial which can be set to a predetermined time interval.

10. The smart busy board in accordance with claim 9, wherein each predetermined time interval is set for engagement of each of said plurality of interactive components.

11. The smart busy board in accordance with claim 8, wherein said self-moving interactive components are selected from the group consisting of a vintage typewriter keyboard, a vintage on/off sign, a vintage rotary phone, an hour glass, a pair of gear wheels, a zipper, a sliding latch and lock, a classic doorknocker, a doorknob with key, a standard press doorbell, a hinged door, a chain lock, a swing bar lock, a padlock, a keys-on-a-chain, a set of Velcro straps, and a zig-zag pattern with bar member.

12. The smart busy board in accordance with claim 8, wherein at least some of said plurality of interactive components are not connected to said electrical elements and are selected from the group consisting of a flip page front facing moving picture book manually controlled by a round disc member, a column of magnetized book shelves, each book shelf being color coded to a corresponding color coded magnet in the form of a book, a fabric collection, a tooth brush bristle, a xylophone, a shoe having shoelaces, a door member capable of being manually opened to reveal a mirror, and a pair of buttonable fabric pieces.

13. The smart busy board in accordance with claim 11, wherein at least some of said plurality of interactive components are not connected to said electrical elements and are selected from the group consisting of a flip page front facing moving picture book manually controlled by a round disc member, a column of magnetized book shelves, each book shelf being color coded to a corresponding color coded magnet in the form of a book, a fabric collection, a tooth brush bristle, a xylophone, a shoe having shoelaces, a door member capable of being manually opened to reveal a mirror.

14. The smart busy board in accordance with claim 13, wherein said timer dial is set to a predetermined time interval for engagement of each of said plurality of interactive components.

15. The smart busy board in accordance with claim 8, wherein said predetermined time interval can be set in 30 second intervals from 30 seconds to 120 seconds.

16. The smart busy board in accordance with claim 13, wherein said plurality of interactive components comprises a vintage typewriter keyboard, a flip page front facing moving picture book manually controlled by a round disc member, a vintage on/off sign electrically connected to a switch member, a column of magnetized book shelves, each book shelf being color coded to a corresponding color coded magnet in the form of a book, a vintage rotary phone, a fabric collection, a tooth brush bristle, a xylophone, an hour glass, a pair of gear wheels, a shoe with shoelaces, a zipper, a sliding latch and lock, a hinged door having a mirror disposed therein, a classic doorknocker, a doorknob with key and a standard press doorbell.

17. The smart busy board in accordance with claim 13, wherein said plurality of interactive components comprises a hinged door, a vintage typewriter keyboard, a doorknob and key, a padlock, keys-on-a-chain, a chain lock, a swing bar lock, a vintage rotary phone, a shoe with shoelaces, a zipper, a pair of buttonable fabric pieces, a set of Velcro straps, and a zig-zag pattern with bar member.

18. The smart busy board in accordance with claim 1, wherein the length of the busy board 100, is between about thirty inches (30″) and about thirty-six inches (36″), the height is between about twenty-two inches (22″) and about twenty-eight inches (28″), and the depth is between about four inches (4″) and about six inches (6″), the depth being of sufficient size such the electrical elements of the busy board can be securely stored and hidden within said interior space.
